(19) United States
(12) Patent Application Publication
(10) Pub. No.: US 2026/0131530 A1
(43) Pub. Date: May 14, 2026

(54) APPARATUS AND METHOD FOR CLEANING DEPOSITED MATERIAL IN AN ADDITIVE MANUFACTURING

(71) Applicant: Supernova Industries Corp., Austin, TX (US)

(72) Inventors: Roger Antunez Francisco, Barcelona (ES); Marta Mico Martinez, Barcelona (ES); Boris Agea Blanco, Barcelona (ES); Dervla Braem, Barcelona (ES); Manuel Joao Martins Barroeta, Barcelona (ES); Eric Pallares Garcia, Barcelona (ES); Oriol Bel Laveda, Barcelona (ES)

(21) Appl. No.: 19/383,015

(22) Filed: Nov. 7, 2025

Related U.S. Application Data
(60) Provisional application No. 63/718,414, filed on Nov. 8, 2024.

(51) Int. Cl. B29C 64/188; B29C 64/35; B33Y 40/00

(52) U.S. Cl. CPC B29C 64/188; B29C 64/35; B33Y 40/00

(57) ABSTRACT

A system and method for removing excess polymer precursor. The system includes a print bed, a light engine positioned over the print bed, a first elongate carriage suspended between the print bed and the light engine, and a first blade connected to the first elongate carriage. The first elongate carriage is movable in a first plane parallel to a second plane defined by the print bed. A first layer of an at least partially cured first polymer precursor is formed on the print bed, the first elongate carriage is advanced and the first blade contacts the first layer of the at least partially cured polymer precursor. The uncured first polymer precursor from the first layer of the at least partially cured first polymer precursor is removed with the first blade and the first elongate carriage is retracted.

### FIELD

The present disclosure relates to a system and method for cleaning deposited material in an additive manufacturing process, and in particular embodiments, cleaning deposited material in multi-material additive manufacturing.

### BACKGROUND

Additive manufacturing is a process of forming parts by depositing one or more materials layer by layer, “building up” a component. The process generally utilizes digital computer models, such as a computer-aided designs or digital 3D models, sliced into layers, to control the selective deposition, melting, curing, and/or binding of material. Additive manufacturing accommodates complex geometries without the need for molds or dies. There are a number of additive manufacturing techniques that can be used for the formation of parts from liquid resin materials. For example, stereolithography (SLA) printing uses laser light to cure liquid resin stored in a vat by tracing the layer geometry with the laser. Digital light processing (DLP) uses light projected onto a vat to cure an entire layer of liquid resin all at once.

However, the processes noted above use resin precursors, exhibiting viscosities of less than 10,000 centipoise at room temperature (20 degrees Celsius). In processes for these materials, the resin precursors are generally gravity fed or use pumps to feed material into a printing vat or deposit material. These resins may lead to poor mechanical properties due to the composition of the precursors. As a result, the parts obtained are not always suitable for end-use and industrial applications. These applications include but are not limited to seals, structural brackets, automotive components such as under-the-hood parts and electrical connectors, footwear components including outer soles and orthoses, healthcare applications such as hearing aid components and medical devices, and battery components.

There are many challenges in manufacturing components formed from relatively high viscosity precursors, including material processibility due to the higher viscosity, the formation of voids, and poor layering. While extrusion and casting have been used in forming viscous polymers, geometries formed using these methods are limited. In addition, extrusion dies and molds are usually necessary for forming these materials.

Accordingly, room remains for improvement of additive manufacturing systems and methods for improved manufacturing resins having viscosities of 20,000 centipoise or greater, including systems and methods for multi-material processing.

### SUMMARY

According to various embodiments, the present disclosure relates to a system for removing excess polymer precursor. The system includes a print bed, a light engine positioned over the print bed, a first elongate carriage suspended between the print bed and the light engine, wherein the first elongate carriage defines a first base, and a first blade connected to the first elongate carriage, wherein at least a portion of the first blade extends from the first base. The first elongate carriage is movable in a first plane parallel to a second plane defined by the print bed.

In embodiments of the above, the first elongate carriage is movable in the first plane by a linear actuator and the first elongate carriage is connected to a track.

In any of the above embodiments, the first elongate carriage includes a first end and a second end and is connected to a track at each end.

In any of the above embodiments, the linear actuator is a motor and a pulley.

In further embodiments, the first elongate carriage is connected to the track by a bracket, wherein the bracket and the track include a linear encoder.

In any of the above embodiments, the system further includes an additional elongate carriage, wherein the additional elongate carriage includes an additional blade extending from a base of the additional elongate carriage.

In any of the above embodiments, the system further includes a first elongate brush connected to the first elongate carriage, wherein at least a portion of the first elongate brush extends from the first base.

In further embodiments, a second blade movable relative to the print bed, wherein the first blade is located proximal to a first side of the first elongate brush and second blade is located proximal to a second side of the first elongate brush.

In any of the above embodiments, the first elongate carriage further includes a second blade.

In any of the above embodiments, the system further includes a second elongate carriage suspended over the print bed, wherein the second elongate carriage defines a second base; a third blade connected to the second elongate carriage, wherein at least a portion of the third blade extends from the second base; and a second elongate brush connected to the second elongate carriage, wherein at least a portion of the second elongate brush extends from the second base.

In any of the above embodiments, the first blade includes at least one of spatula, an air blade, and a conveyor belt.

In any of the above embodiments, the system further includes at least one of a scraper and an absorbent pad, wherein the first blade contacts the at least one of the scraper and the absorbent pad when moved to a rest position.

In further embodiments, the scraper extends out of a catch basin, wherein the scraper includes at least one first curved edge extending a width of the first blade and is positioned at a height that allows the first blade to contact the first curved edge upon passing over the first curved edge.

In further embodiments, the e scraper further includes a second curved edge and the second curved edge is curved in the opposite direction of the first curved edge, and the scraper defines openings in a base of the scraper extending between the first curved edge and the second curved edge.

According to various aspects, the present disclosure relates to a method for removing excess polymer precursor from an additive manufacturing machine. The method includes forming a first layer of an at least partially cured first polymer precursor on a print bed, advancing a first elongate carriage suspended over the print bed, wherein the first elongate carriage defines a first base, and a first blade connected to the first elongate carriage, wherein at least a portion of the first blade extends from the first base to contact the first layer of the at least partially cured first polymer precursor, removing uncured first polymer precursor from the first layer of the at least partially cured first polymer precursor with the first blade, and retracting the first elongate carriage.

In embodiments of the above, the method further includes cleaning the uncured first polymer precursor from the first blade with a scraper having a first curved edge, wherein the first curved edge of the scraper contacts the first blade.

In any of the above embodiments, the method further includes depositing the first layer of a first polymer precursor on a transfer film, contacting the print bed with the first polymer precursor, and emitting light onto the first polymer precursor.

In any of the above embodiments, the method further includes forming a second layer of an at least partially cured second polymer precursor on the print bed, advancing a second elongate carriage suspended over the print bed, wherein the second elongate carriage defines a second base, a second blade connected to the second elongate carriage, wherein at least a portion of the second blade extends from the second base, and a second elongate brush connected to the second elongate carriage, wherein at least a portion of the second elongate brush extends from the second base to contact the second layer of the at least partially cured second polymer precursor, removing excess second polymer precursor from the second layer of the at least partially cured second polymer precursor with the second blade and the second elongate brush, and retracting the second elongate carriage.

In embodiments of the above, the method further includes depositing a second layer of a second polymer precursor on a transfer film, contacting the first layer with the second polymer precursor, and emitting light onto the second polymer precursor.

In any of the above embodiments, the method further includes forming a second layer of an at least partially cured second polymer precursor on the print bed, advancing the first elongate carriage suspended over the print bed, wherein the first elongate carriage includes a second blade connected to the first elongate carriage, wherein at least a portion of the second blade extends from the first base, and a second elongate brush connected to the first elongate carriage, wherein at least a portion of the second elongate brush extends from the first base to contact the second layer of the at least partially cured second polymer precursor, removing excess second polymer precursor from the second layer of the at least partially cured second polymer precursor with the second blade and the second elongate brush, and retracting the first elongate carriage.

### BRIEF DESCRIPTION OF THE DRAWINGS

The drawings described herein are for illustration purposes only and are not intended to limit the scope of the present disclosure in any way.

FIG. 1 illustrates a front view of an additive manufacturing machine according to embodiments of the present disclosure.

FIG. 2 illustrates a print bed, support surface, and light engine according to embodiments of the present disclosure.

FIG. 3 illustrates the transfer film management system, according to embodiments of the present disclosure.

FIG. 4 illustrates a cleaning system, according to embodiments of the present disclosure.

FIG. 5 illustrates a cleaning system, according to embodiments of the present disclosure.

FIG. 6 illustrates a bottom perspective view of a carriage of FIG. 5, according to embodiments of the present disclosure.

FIG. 7 illustrates a side perspective view of a carriage of FIG. 5, according to embodiments of the present disclosure.

FIG. 8 illustrates a cross-section of a carriage of FIG. 5, according to embodiments of the present disclosure.

FIG. 9 illustrates a side perspective view of a carriage of FIG. 5 with cover panels removed, according to embodiments of the present disclosure.

FIG. 10 illustrates a cleaning system, according to embodiments of the present disclosure.

FIG. 11 illustrates a side view of the cleaning system of FIG. 10, according to embodiments of the present disclosure.

FIG. 12 illustrates a front perspective view of the cleaning system of FIG. 10, according to embodiments of the present disclosure.

FIG. 13 illustrates a cross-sectional top perspective view of the cleaning system of FIG. 10, according to embodiments of the present disclosure

FIG. 14 illustrates a cross-sectional bottom perspective view of the cleaning system of FIG. 10, according to embodiments of the present disclosure

FIG. 15 illustrates flow chart of a method of cleaning excess polymer precursor on a printed component, according to embodiments of the present disclosure.

FIG. 16 illustrates a control system associated with the additive manufacturing device, according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure relates to systems and methods for cleaning excess polymer precursor from a printed component during printing in additive manufacturing. The systems and method may be used with photopolymer precursors that exhibit pre-cursor viscosities of 20,000 centipoise or greater, such as up to 5,000,000 centipoise. However, while the system and method are described for use with photopolymer precursors exhibiting a photopolymer pre-cursor viscosity of 20,000 centipoise or greater, the system and method may be used with photopolymer precursors exhibiting a pre-cursor viscosity of less than 20,000 centipoise. In addition, while the systems and methods described herein may be used to make seals, structural brackets, automotive components such as under-the-hood parts and electrical connectors, footwear components including outer soles and orthoses, healthcare applications such as hearing aid components and medical devices, and battery components, other printed components may be formed using the system and methods described herein.

The photopolymer polymer precursors exhibit a viscosity of 10,000 centipoise or greater, such as in the range of 1 centipoise to 5,000,000 centipoise, including all values and ranges therein such as in the range of 20,000 centipoise to 100,000 centipoise, 100,000 centipoise to 1,000,000 centipoise, etc. Light, exhibiting one or more wavelengths in the range of 250 nanometers to 750 nanometers, including all values and ranges therein, is used to polymerize the resin precursors. In embodiments, the precursors are cured using light exhibiting one or more wavelengths in the range of 320 nanometers to 435 nanometers, including all values and ranges therein. In embodiments, the polymer precursors include at least one of a monomer and an oligomer, at least one photoinitiator, and, optionally, one or more fillers and additives.

The monomers and oligomers include, but are not limited to, one or more of the following: acrylate, methacrylate, vinyl, thiol, epoxy, oxetane, hydroxy, and hydride functional liquid silicones, liquid polyurethanes, urethane monomers, rubbers, and polybutadienes. In further embodiments, the monomers and oligomers include methacrylate and acrylate functional groups on linear, branched, star, or comb urethane, silicone, or polyolefin (polypropylene, polyethylene) backbones. The photoinitiators, in embodiments, include at least one of a type I photoinitiators such as hydroxyacetophenone (HAP) and phosphineoxide such as diphenyl(2,4,6-trimethylbenzoyl)phosphine oxide (TPO), ethyl (2,4,6-trimethylbenzoyl) phenylphosphinate (TPO-L), phenylbis(2,4,6-trimethylbenzoyl)phosphine oxide (BAPO)), and a type II photoinitiator such as Benzophenone and benzophenone-type photoinitiators, which also require the use of a co-initiator such as an alcohol, amine, thiol or otherwise. The photoinitiators (and co-initiators, if present) are present in the range of 0.01 percent by weight to 5 percent by weight, including all values and ranges therein.

The fillers include, but are not limited to one or more of the following: ceramics including silica, alumina, zirconia, ferrites, barium titanate, silicon carbide, silicon nitride, boron carbide, hydroxyapatite, aluminum trihydrate, zinc oxide, and combinations thereof; metals including but not limited to one or more transition metals, which are understood as metals that include valence electrons in two shells instead of only one; and metal alloys, which are understood to include one or more metals or one or more metals with one or more non-metallic elements. Other additives may be added including plasticizers such as dioctyl adipate, diisooctyl phthalate; and additional fillers such as silica in non-ceramic based formulations, glass, and organic materials such as rosin, amine, amide, poly amide, polyurethane, urethane, melamine, phosphinate etc. The fillers are inclusive of all morphology including but not limited to spheres, fibers, flakes, tubes, milled, ground, natural, and cubes. The fillers may be present in the range of 0.1 percent by weight to 90 percent by weight of the total weight of the polymer precursor, including all values and ranges therein such as 0.1 percent by weight to 10 percent by weight, 10 percent by weight to 25 percent by weight, etc. The polymer precursors including fillers may exhibit a viscosity in the range of 20,000 to 5,000,000 centipoise at room temperature (23 degrees Celsius), including all values and ranges therein.

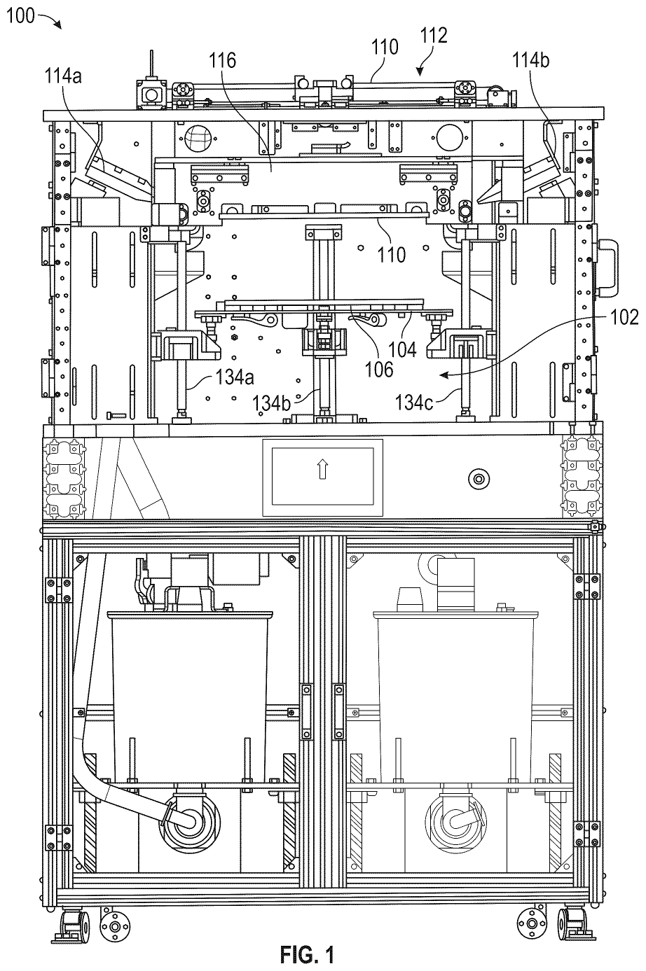

FIG. 1 illustrates an additive manufacturing machine 100 for forming components using, but not limited to, the polymer precursors described above. The additive manufacturing machine 100 defines a process chamber 102. In some embodiments, the temperature and the humidity are controlled within the process chamber 102. Within the process chamber 102 is a print bed 104 including a support surface 106 on which a component is printed. The additive manufacturing machine 100 further includes a transfer film 110 and a transfer film management system 112 for moving the transfer film 110 back and forth between one or more material feed systems 114a, 114b and a light engine 116 over the print bed 104. In embodiments, the transfer film 110 is selected based on physiochemical properties between the transfer film 110 and the polymer precursor that define the peeling force per unit area to release an at least partially cured layer of polymer precursor from the transfer film 110. Further, the transfer film 110 must be optically transparent to the light emitted from the light engine 116.

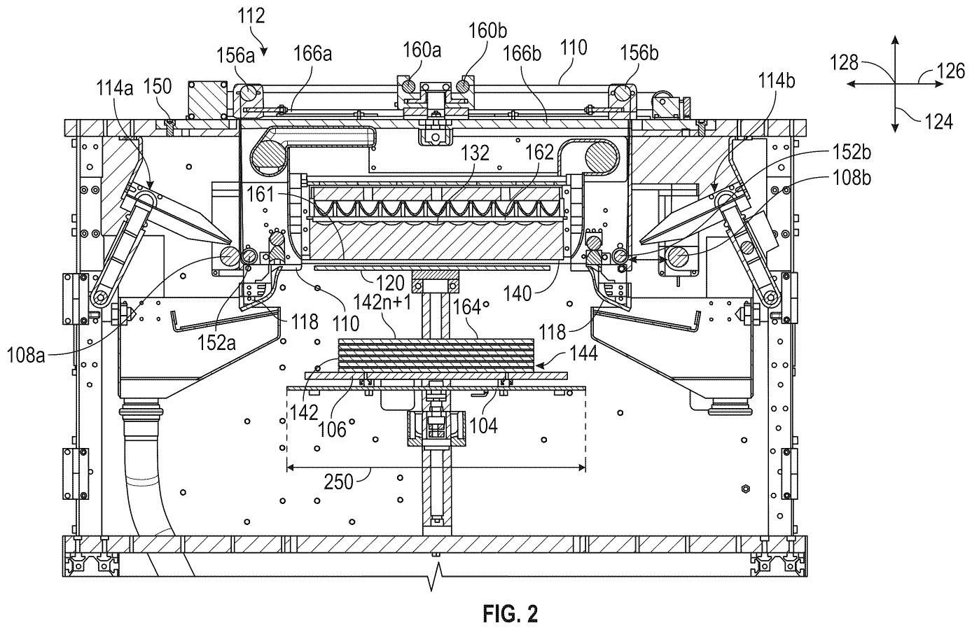

In operation, as illustrated in FIG. 2, a layer 120 of the polymer precursor is dispensed by one of the material feed systems 114a, 114b onto a lamination roll 108a, 108b and the transfer film 110 as the transfer film 110 is moved from the material feed system 114a, 114b to the light engine 116. The layer 120 of the polymer precursor is positioned over the support surface 106 of the print bed 104 and under the light engine 116. The support surface 106 is then raised in a first axis 124, the “z-direction”, toward the transfer film 110 and contacts the polymer precursor layer 120. The light source 132 in the light engine 116 is activated and light is emitted and projected through the transfer film 110 onto the polymer precursor at a sufficient dosage and in specific locations to at least partially cure or solidify the polymer precursor to form the next component layer. If previous layers 142, 142n+1 of the component 144 are present, the polymer precursor may also bind to the previously printed layers. The at least partially cured polymer precursor is transferred to the support surface 106 of the print bed 104 or the previously printed layer 142n+1 and the print bed 104 is lowered along the first axis 124. After the at least partially cured polymer precursor is deposited onto the print bed 104 by transferring the at least partially cured layer on the print bed 104, excess photopolymer precursor on the transfer film 110 is removed from the transfer film 110 by one or more squeegees 118. Further excess polymer precursor is removed from the component 144 being printed by a cleaning device 220. The process is then repeated until the component 144 is complete.

Referring again to FIG. 1, the print bed 104 is coupled to at least three linear actuators 134a, 134b, 134c for moving the print bed 104 up and down in the first axis 124, i.e., the z-direction. In alternative embodiments, one, two, four or more linear actuators may be provided. The linear actuators 134a, 134b, 134c may each include, for example, a threaded spindle and ball screw drive, roller screw drive, linear motor, etc. The print bed 104 is connected to the linear actuators 134a, 134b, 134c using ball joints allowing the print bed 104 to move in an angular direction. Movement of the linear actuators 134a, 134b, 134c at the same rate allows for the print bed 104 to maintain parallelism with the base 140 of the light engine 116 as it is raised and lowered along the first, z-axis 124.

Each linear actuator 134a, 134b, 134c may also be separately adjusted so that the print bed 104 may be angled at various angles from the plane defined by a second axis 126 and a third axis 128 orthogonal to both the first axis 124 and the second axis 126 up to 20 degrees in any given direction. Angling the print bed 104 while raising the support surface 106 up to the transfer film 110 may assist in reducing void formation between the at least partially cured polymer precursor being transferred and the previously transferred layer 142n+1 (see FIG. 2) or the support surface 106, itself. Angling of the print bed 104 and support surface 106 may also be used to assist in peeling the at least partially cured polymer precursor being transferred from the transfer film 110.

Mounted on the print bed 104 is a support surface 106 on which the various layers 142, 142 n+1 of the component 144 are transferred during printing (see FIG. 2). The support surface 106 is, in embodiments, removably mounted onto the print bed 104 to facilitate removal of printed components 144 from the print bed 104 as well as to allow for the use of different support surface 106 materials based on the polymer precursor. In addition, while the support surface 106 is illustrated as being relatively flat and rectangular, the support surface 106 may exhibit other geometries and have a relatively circular or oblong surface or exhibit a relatively curvate shape in the z-axis. Further, the support surface 106 may exhibit various surface finishes and textures to prevent slippage of the component during printing, facilitate release of the printed component, or both prevent slippage of the component during printing and facilitate release of the printed component. Additionally, the support surface 106 may exhibit various coatings to prevent slippage of the component during printing, facilitate release of the printed component, or both prevent slippage of the component during printing and facilitate release of the printed component. In yet further embodiments, the support surface 106 may include a flexible release surface on which the component 144 is printed. The flexible release surface may be held onto the support surface by one or more of mechanical and magnetic means.

As noted above and referring again to FIG. 2, the transfer film 110 is moved back and forth between the material feed systems 114a, 114b, the light engine 116, and the squeegees 118 by a transfer film management system 112. The transfer film management system 112 includes a first platform 150, idle rollers 152a, 152b (see FIG. 2), tension rollers 156a, 156b, and retention mounts 160a, 160b. Openings 166a, 166b in the first platform 150 accommodate the movement of the transfer film 110 between the idle rollers 152a, 152b and the tension rollers 156a, 156b.

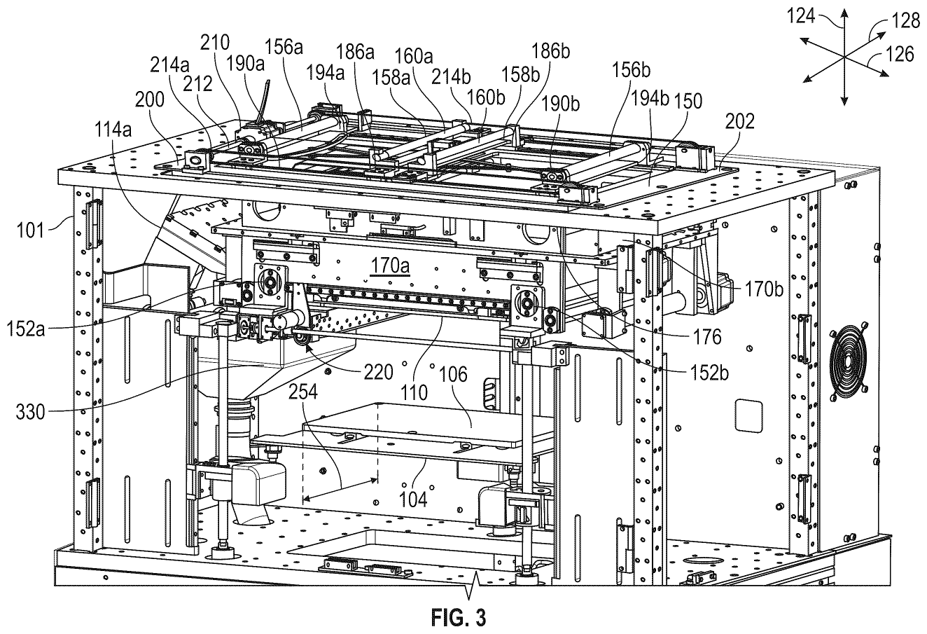

With reference to FIG. 3, the idle rollers 152a, 152b space the transfer film 110 from the base 140 of the light engine 116 in the first axis 124, so that the transfer film 110 touches and slides across the base 140 of the light engine 116 reducing the stress that may be incurred if the transfer film 110 passed over the corners of the light engine 116 on either side of the base 140. In some embodiments, the idle rollers 152a, 152b rotate with the transfer film 110 as the transfer film 110 is shuttled back and forth relative to the material feed system 114a, 114b and the light engine 116. The idle rollers 152a, 152b are supported at either end of each roller in a rotating manner by a first side bracket 170a and a second side bracket 170b. The first side bracket 170a and the second side bracket 170b are parallel. In addition, the first side bracket 170a and the second side bracket 170b are connected to and extend from the base 176 of the first platform 150. Alternatively, the first side bracket 170 and second side bracket 172 may be connected to and extend from the frame 101 of the additive manufacturing machine 100. The transfer film 110 is also supported by the tension rollers 156a, 156b, which in some embodiments may rotate with the transfer film 110 as it passes over the tension rollers 156a, 156b.

The transfer film 110 is secured at each end 158a, 158b to retention mounts 160a, 160b, which in the illustrated embodiment are rollers. The first retention mount 160a is secured on a first carriage 186a and the second retention mount 160b is secured to a second carriage 186b. The first carriage 186a and the second carriage 186b span the first platform 150 in the third axis 128. The first carriage 186a and the second carriage 186b are movably connected to rails 190a, 190b at either end of the carriages 186a, 186b. The first rail 190a and second rail 190b are parallel.

The first tension roller 156a is supported by a third carriage 194a and the second tension roller 156b is supported by a fourth carriage 194b that each span the first platform 150. The tension rollers 156a, 156b are located proximal to the ends 200, 202 of the first platform 150 and the retention mounts 160a, 160b are located inward of the tension rollers 156a, 156b. The third carriage 194a and fourth carriage 194b are slidably connected to the rails 190a, 190b and move back and forth on the rails 190a, 190b along the second axis 126. The tension rollers 156a, 156b are each adjustably spaced from the retention mounts 160a, 160b to alter the tension on the transfer film 110.

In operation, the transfer film 110 is secured at a first end to the first retention mount 160a, is wrapped around the first tension roller 156a, through the first opening 166a, around the first idle roller 152a, adjacent to the base 140 of the light engine 116, around the second idle roller 152b, up through the second opening 166b, around the second tension roller 156b and is secured to the second retention mount 160b. In this manner, the transfer film exhibits a trapezoidal, or “C” shape. A motor 210 is coupled to a shaft 212, which drives the second carriage 180b back and forth by a set of pulleys 214a, 214b.

In alternative embodiments, the ends 158a, 158b of the transfer film 110 are not connected to the retention mounts 160a, 160b but are connected together and the transfer film 110 rotates completely around, rather being shuttled back and forth. In such an embodiment, the pulleys 214a, 214b are coupled to at least one of the tension rollers 156a, 156b or at least one of the retention mounts 160a, 160b to drive the roller(s). In further embodiments, one or more of the driven rollers, i.e., the tension rollers 156a, 156b or the retention mounts 160a, 160b, include a sprocket or other device that engages with the transfer film 110 and rotates the transfer film 110 in complete circles.

With reference again to FIG. 2, the light engine 116 includes a light source 132. The light source 132 is spaced away from a transparent plate 161, such as a glass plate of a liquid crystal display, through which light emitted from the light source 132 passes. The transparent plate 161 also serves as a support for the transfer film 110, particularly as the print bed 104 and support surface 106 are elevated to contact a polymer precursor layer 120. The light source 132 may include, but is not limited to, for example light emitting diodes, a liquid crystal display, and mercury lamps. The light source 132 may include an array of individual light sources 132 is illustrated. Further, in embodiments, a light emitting diode array including one or more elements 162 including at least one of optical elements or refractive elements providing at least one of collimation, a pixilated display, a projector, or a physical mask may be used to make the desired shapes and patterns for each cross section. The light source 132 may exhibit a power density as measured at the surface 164 of the previously transferred layer 142n+1 of 3 milliwatts per centimeter squared to 1000 milliwatts per centimeter squared, including all values and ranges therein, such as 4 milliwatts per centimeter squared to 10 milliwatts per centimeter squared, 100 milliwatts per centimeter squared to 500 milliwatts per centimeter squared. As noted above, the light emitted from the light source 132 exhibits one or more wavelengths in the range of 250 nanometers to 750 nanometers, including all values and ranges therein, such as one or more wavelengths in the range of 250 nanometers to 435 nanometers.

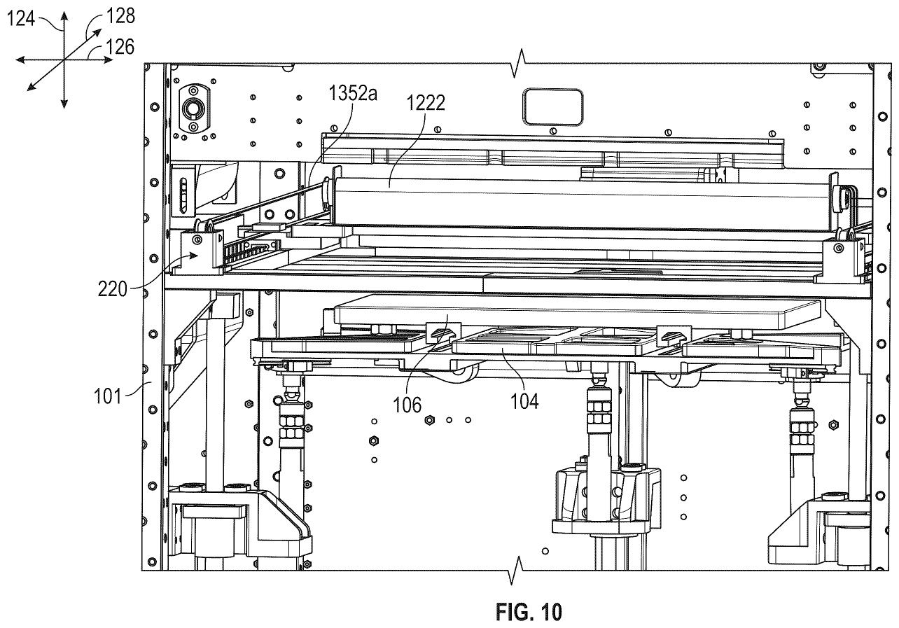

FIGS. 3 and 10 illustrate embodiments of a cleaning system 220 suspended over the support surface 106 of the print bed 104 and moveable over the print bed in a first plane parallel to a second plane generally defined by the support surface 106 for cleaning excess, uncured polymer precursor from layers 142, 142n+1 of the component 144 formed on a substrate, which includes either the support surface 106 if layers are not yet printed or a previously deposited layer 142 n, 142n+1 (as illustrated in FIG. 2).

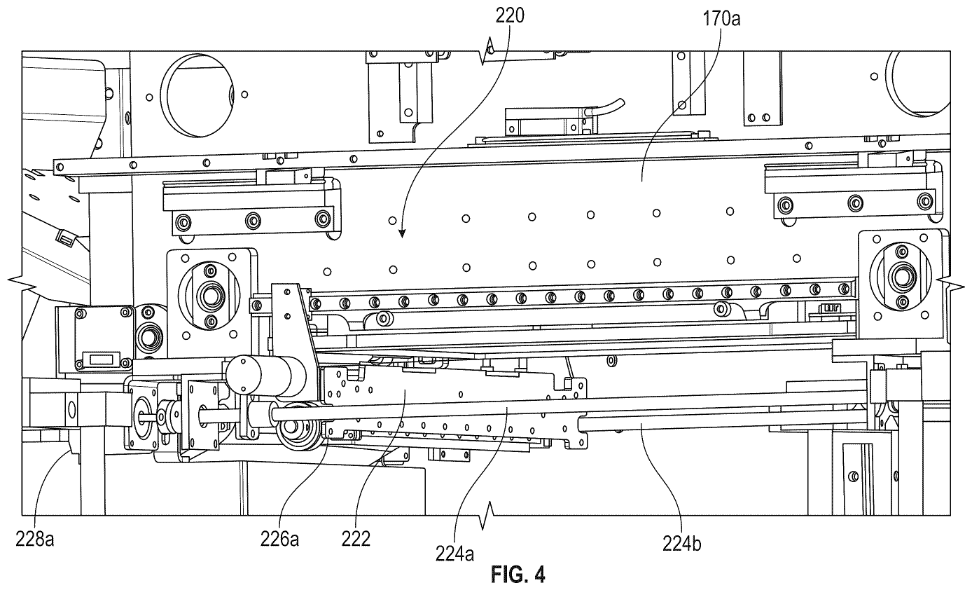

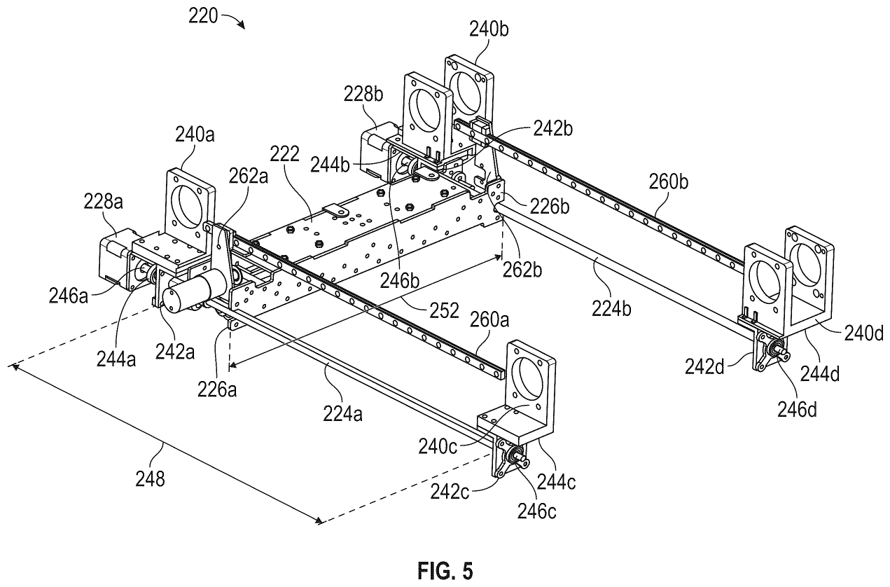

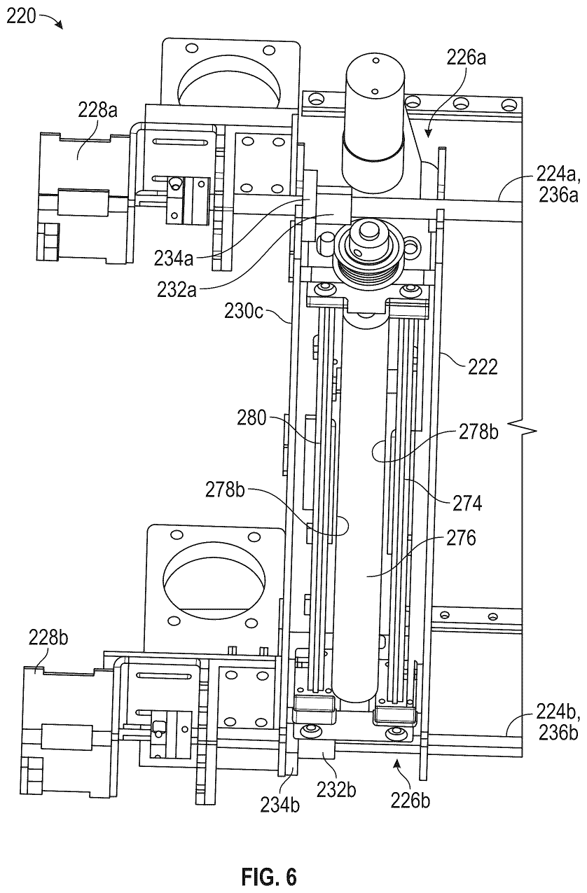

FIG. 4 and FIG. 5 illustrate an embodiment of the cleaning system 220. The cleaning system 220 includes a first elongate carriage 222. While a single carriage 222 is illustrated, more than one carriage may be present as described further herein. The first elongate carriage 222 is movable along the second axis 126 by a set of linear actuators 224a, 224b connected to the sides 226a, 226b of the first elongate carriage 222. In embodiments, the linear actuators 224a, 224b include may each include, for example, a stepper motor and a belt transmission, a motor and a pulley system as described further below, a motor and spindle assembly, a rack and pinion, a threaded spindle and ball screw drive, roller screw drive, etc. As illustrated in FIG. 6, the exterior facing side plate 230c is connected to a threaded bore 232a, 232b extending from a base plate 234a, 234b, one located at each side 226a, 226b of the first elongate carriage 222. The threaded bore 232a, 232b is received a threaded spindle 236a, 236b, which rotates within the threaded bore. A motor 228a, 228b drives each linear actuator 224a, 224b. Further, in the illustrated embodiment, the linear actuators 224a, 224b support the first elongate carriage 222 over the support surface 106 and print bed 104.

Referring to FIG. 5, the linear actuators 224a, 224b are supported at each end by a primary bracket 240a, 240b, 240c, 240d. The primary brackets 240a, 240b, 240c, 240d are mounted to the first side bracket 170a and second side bracket 170b. The primary brackets 240a, 240b, 240c, 240d may be either “L” shaped, such as primary brackets 240a, 240c, or “U” shaped, such as primary brackets 240b, 240d. As illustrated, the linear actuators 224a, 224b are connected to secondary brackets 242a, 242b, 242c, 242d that are connected to the base 244a, 244b, 244c, 244d of the primary brackets 240a, 240b, 240c, 240d. Alternatively, the linear actuators 224a, 224b may be connected directly to the primary brackets 240a, 240b, 240c, 240d, which may include projections from the base of the primary brackets 240a, 240b, 240c, 240d for receiving the linear actuators 224a, 224b. The linear actuators 224a, 224b are supported by the primary brackets 240a, 240b at a first end 246a, 246b proximal to the motor 228a, 228b and supported by the primary brackets 240c, 240d proximal to a second end 246c, 246d. The distance 248 between the primary brackets 240a, 240b, 240c, 240d at each end 246a, 246b, 246c, 246d allows the first elongated carriage 222 to travel the entire length 250 of the support surface 106 and print bed 104(see FIG. 2) and past the ends of the support surface 106 and print bed 104 so that the support surface 106 and print bed 104 may be raised without contacting the first elongated carriage 222. Further, the first elongate carriage 222 exhibits a length 252 sufficient to span the entire width 254 of the print bed (see FIG. 3).

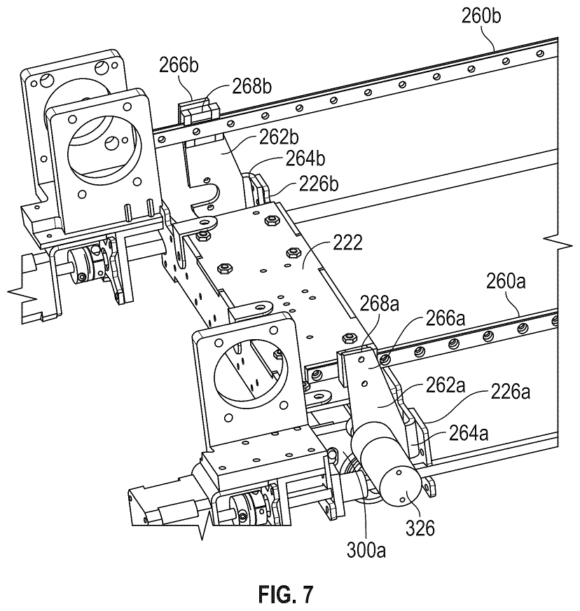

In embodiments, a first track 260a is mounted to the first bracket 170a and a second track 260b is mounted to the second bracket 170b. With reference to FIG. 7, the carriage 222 is slidably connected to the tracks 260 a, 260 b, by way of two uprights 262a, 262 b. The first upright 262a is connected at its base 264 a to a first side 226 a of the carriage 222 and the second upright 262b is connected at its base 264b to the second side 226b of the carriage 222. The upper portion 266 a, 266 b of each upright 262a, 262 b defines a channel 268 a, 268b. The first channel 268a receives the first track 260a and the second channel 268b receives the second track 260b. In embodiments, the channels 268a, 268b may include sensors that interact with the track to determine the linear position of the carriage 222 relative to the support surface 106 in the direction of the second axis 126, along the length of the support surface 106. In embodiments, a determination may be made as to whether the first elongated carriage 222 is positioned in a parked position where the first elongated carriage 222 may be cleaned or out of the way of the moving support surface 106. In embodiments, sensors are at least one of a linear encoder or a magnetic sensor.

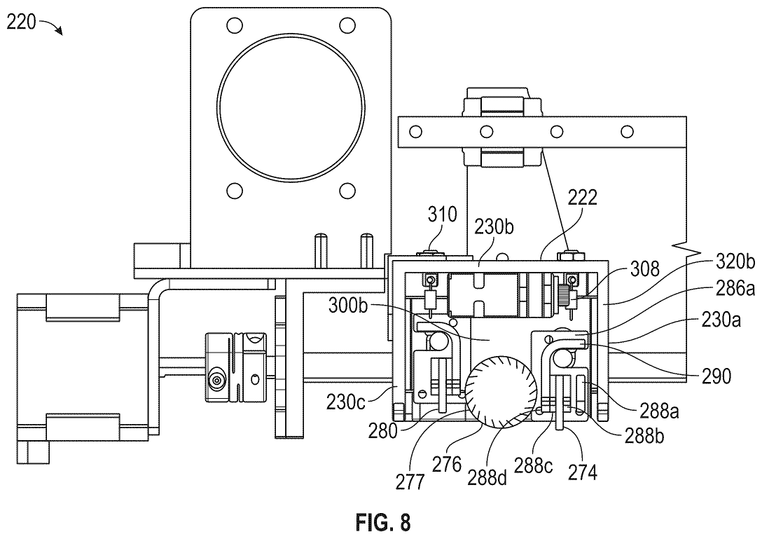

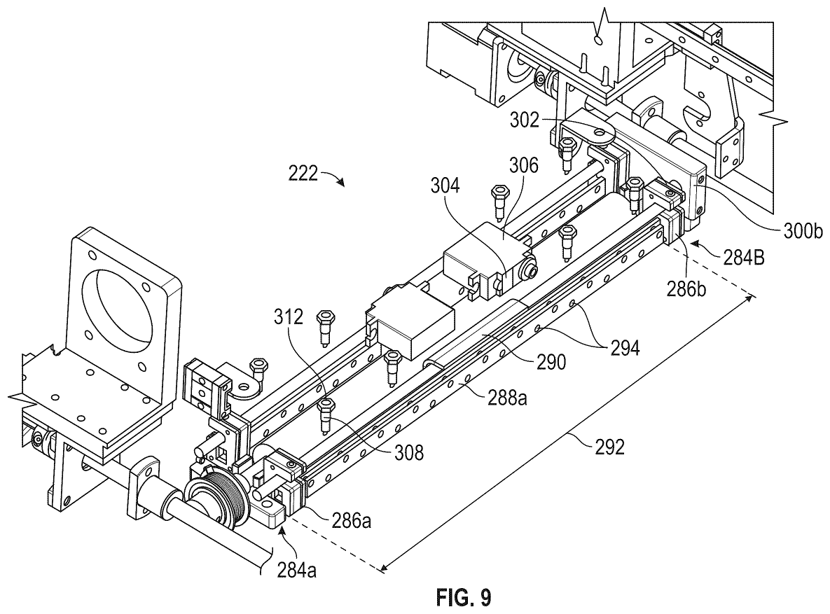

With reference to FIG. 6, FIG. 8, and FIG. 9, a first blade 274 and a first elongate brush 276 are mounted within the first elongate carriage 222. The first blade 274 and first elongate brush 276 are oriented such that the length 252 (see FIG. 5) of the first blade 274 and first elongate brush 276 is parallel to the third axis 128. The first blade 274 is mounted adjacent a first side 278a of the first elongate brush 276. In embodiments, a second blade 280 is mounted adjacent a second side 278b of the first elongate brush 276 opposing the first side 278a of the first elongate brush 276 as illustrated in the figures. Additional blades and brushes may also be present, exhibiting the same geometry or different geometries. In preferred embodiments, one or more blades and one or more brushes are present for each polymer precursor the additive manufacturing machine 100 is configured to dispense. Further, the one or more blades and one or more brushes for each polymer precursor may be carried by a single carriage, or by multiple carriages.

The blades 274, 280 and first elongate brush 276 each exhibit a length 292 greater than the width 254 of the print bed 104. In embodiments, the length of the blades 274, 280 are different than the length of the first elongate brush 276; however, the blades 274, 280 and first elongate brush 276 still each exhibit a length 292 greater than the width 254 of the print bed 104. In further embodiments, the first blade 274 and second blade 280 are adjustably mounted so that the blades 274, 280 may independently move up and down in the first axis 124, closer to and away from the print bed 104.

The blades 274, 280 function like spatulas scraping excess, uncured polymer precursor from the component 144. The blades 274, 280 are formed from a relatively flexible material, such as a natural or synthetic rubber, thermoplastic elastomer, or a thermoplastic block copolymer. In embodiments, the hardness of the blades 274, 280 may be selected based on the polymer precursor and geometry of the component 144. The brush 276 includes bristles 277 extending from the surface of the brush. The bristles 277 act like small spatulas removing excess polymer precursor from crevices, curvate geometries, and interior openings. The bristle length, thickness, and flexural modulus of the bristle material may be selected based on the polymer precursor being printed. The bristles 277 may be formed from a polymer material, such as a thermoplastic polymer. At least one of the blades 274, 280 may contact the component 144 before the first elongate brush 276 or vice versa. In embodiments, the first blade 274 may contact the component 144 then the first elongate brush 276 and then the second blade 280. In alternative embodiments, the first elongate brush 276 may first contact the printed component 144. Further, the first elongate carriage 222 and the cleaning elements, i.e., the brushes and blades may be passed over the component after printing each layer multiple times. During each pass, the height of the blades and brushes to interact with the printed component 144 may be adjusted in varying orders. For example, during a first pass a blade may be lowered to interact with the component, during a second pass a brush may be lowered to interact with the component, and during a third pass the same blade or a different blade may be lowered to interact with the component. In another example, during a first pass a first blade and a first brush may be lowered and during a second pass a second blade and second brush may be lowered and during a third pass a third blade may be lowered. Any number of combinations of lowering the cleaning elements to interact with the component 144 may be used and selected depending on the polymer precursor material and part geometry printed in the last deposited layer 142n+1.

The blades 274, 280 are each captured at a first end 284a by a first hook shaped clamp 286a and at a second end 284b by a second hook shaped clamp 286b as illustrated in FIG. 9. It is noted that for clarity the features associated with blade 274 are illustrated; however, the features are also present on blade 280. The hook shaped clamps 286a, 286b facilitate the removal of the blades 274, 280 for exchanging the blades 274, 280 with other blades of varying materials, flexural modulus, and durometer, which are selected based on the polymer precursor as discussed above. One or more stabilization bars 288a, 288b, 288c are used to hold the blade 274, 280 in place in the first hook shaped clamp 286a and the second hook shaped clamp 286b and prevent the blade 274, 280 from buckling while cleaning the component 144. The stabilization bars 288a, 288b, 288c may also function as shims for accommodating blades 274, 280 of varying thicknesses. If thicker blades 274, 280 are being used, fewer stabilization bars 288a, 288b, 288c may be employed. An additional stabilization bar 288d is also present. This stabilization bar 288d includes a hook 290 along at least a portion of the length 292 of the stabilization bar 288d. In embodiments, the stabilization bars 288a, 288b, 288c, 228d are secured together and to the blade 274, 280 with mechanical fasteners 294.

The first and second hook shaped clamps 286a, 286b and the hook 290 on the stabilization bar 288d hook onto a support bar 296 that suspends the blades 274, 280. The support bar 296 is mounted at each end in a mounting block 300a (see FIG. 7), 300b. The mounting block 300a, 300b includes slots 302 through which the support bar 296 is inserted. In embodiments, the support bar 296 moves up and down by a cam 304 driven by a servomotor 306. The support bar 296 is held in a first retracted position by springs 308 and forced down to a second extended position by the cam 304, where the blade 274, 280 extends from the base 312 of the carriage 222. In embodiments, the second position may be selected based on materials or the geometry of the component to be cleaned. The springs 310 are coupled to fasteners that are mounted in a panel 230b that covers the carriage 222.

In embodiments, the first elongate brush 276 is also suspended, rotatably, by the mounting blocks 300a, 300b and extends from the base 312 of the carriage 222. The rotation is imparted on the first elongate brush 276 by a rotary actuator 326 (see FIG. 7), such as a continuous or stepper electric motor. The rotational direction and speed can be controlled, to adjust the direction and speed according to the material or the geometry to be cleaned.

It should be appreciated that a second carriage, including similar cleaning elements, may be supported over the print bed 104 in a similar manner. The second carriage may be configured for a second polymer precursor. In further embodiments, the carriage 222 is exchangeable with other carriages 222, each carriage 222 being configured for a different material. In yet further embodiments, the individual cleaning elements, i.e., the blades 274, 280 and first elongate brush 276 may be dedicated to specific materials and swapped with other blades and brushes.

Alternatively, or additionally, to the blades 274, 280, one or more of the spatula style blades may be exchanged with an air blade. In such embodiments, the air blade(s) is connected to an air compressor, and the pressure and flow rate of the air may be adjusted depending on the characteristics of the polymer precursor.

In yet further alternative, or additional, embodiments, the blades 274, 280 include a continuous conveyor belt. In embodiments, the continuous conveyor belt is formed from at least one of the following: an absorbent material or one with relatively low surface tension. Further, the conveyor belt is driving by an actuator that drives the rotation of the conveyor belt such as a continuous electric motor or a stepper motor. The conveyor belt includes an “attack zone,” where the conveyor belt meets the surface to be cleaned. In embodiments, the linear speed of the conveyor belt is greater than the advance of the cleaning subassembly and moves in the opposite direction to the advance of the cleaning element carriage, so that the remains of material on the surface are adsorbed and transferred to the conveyor belt. In embodiments, the conveyor belt is affixed to a tilting arm, allowing the contact force between the conveyor belt and the surface to be cleaned to be regulated. Further, a collection area may be provided in which the material from the conveyor belt is evacuated.

As alluded to above, rest or parking areas are provided where cleaning or purging operations can be performed to avoid saturation of the cleaning elements, i.e., the blades 274, 280 and first elongate brush 276 of the cleaning system 220. In the embodiments, the cleaning elements pass over a scraper positioned over a catch basin 330 to a park area. The edge scrapes off the polymer precursor present on the cleaning elements as the cleaning system 220 passes over the catch basin 330. In embodiments, the carriage 222 may be configured to move back and forth over the scrape associated with of the catch basin 330, multiple times or pause as the first elongate brush 276 is rotated against the edge. Alternatively, a cleaning substrate is provided in the park areas, made of an absorbent pad, allowing the spatulas and/or the brushes to be cleaned by friction and interference, or that the brushes are revolved to evacuate excess material. The cleaning substrate must be a consumable, and there must be a constant supply of unsaturated cleaning substrate that allows the necessary cleaning routines of the subassembly.

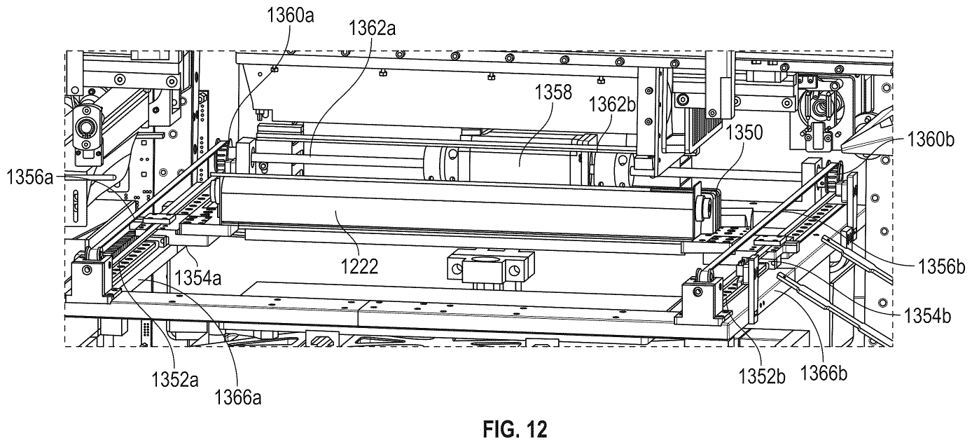

FIGS. 10, 11, and 12 illustrate another embodiment of the cleaning system 220 suspended over a print bed 104. The cleaning system 220 includes a first elongate carriage 1222 and one or more additional elongate carriages 1350, as illustrated three additional elongate carriages are provided. It should be appreciated that any number of additional elongate carriages 1350 may be present in the range of one additional carriage and up to ten additional elongate carriages. The carriages 1222, 1350 ride on parallel tracks 1352a, 1352b located to either side of the carriages 1222, 1350. The tracks 1352a, 1352b are oriented parallel to the third axis 128. The carriages 1222, 1350 are supported at either end by brackets 1354a, 1354b, which include keyways for receiving the tracks 1352a, 1352b. The brackets 1354a, 1354b are shuttled back and forth on the tracks 1352a, 1352b by a set of pulleys 1356a, 1356b, one pulley 1356a, 1356b located at either end of the first elongate carriage 1222 and additional elongate carriages 1350 as illustrated in FIG. 12. While the first elongate carriage 1222 and additional elongate carriages 1350 are illustrated as being affixed to a single bracket 1354a, 1354b at each side, the elongate carriage 1222 and additional elongate carriages 1350 have their own individual brackets at each side. In embodiments, linear encoders are provided in the brackets 1354a, 1354b and tracks 1352a, 1352b to measure the location of the brackets 1354a, 1354b along the tracks 1352a, 1352b.

The pulleys 1356a, 1356b are driven by a motor 1358, which is connected to drive wheels 1360a, 1360b on the pulleys 1356a, 1356b by drive shafts 1362a, 1362b extending from either side of the motor 1358. While a single motor is illustrated, it should be appreciated that, in embodiments, a separate motor may be used to drive each pulley. Further, while a pulley system is illustrated, it should be appreciated that alternate systems may be used such as the linear actuators described above. In addition, the distance between the brackets 1354a, 1354b allows the elongate carriage 1222 and additional carriages 1350 to travel the entire length 250 of the support surface 106 and print bed 104 and past the ends of the support surface 106 and print bed 104 so that the support surface 106 and print bed 104 may be raised without contacting the first elongated carriage 1222 and additional carriages 1350. Further, the first elongate carriage 1222 and additional carriages 1350 exhibit a length sufficient to span the entire width 254 of the print bed (see FIG. 3). In embodiments, the tracks 1352a, 1352b are mounted to rails 1366a, 1366b, which are mounted to the printer frame 101.

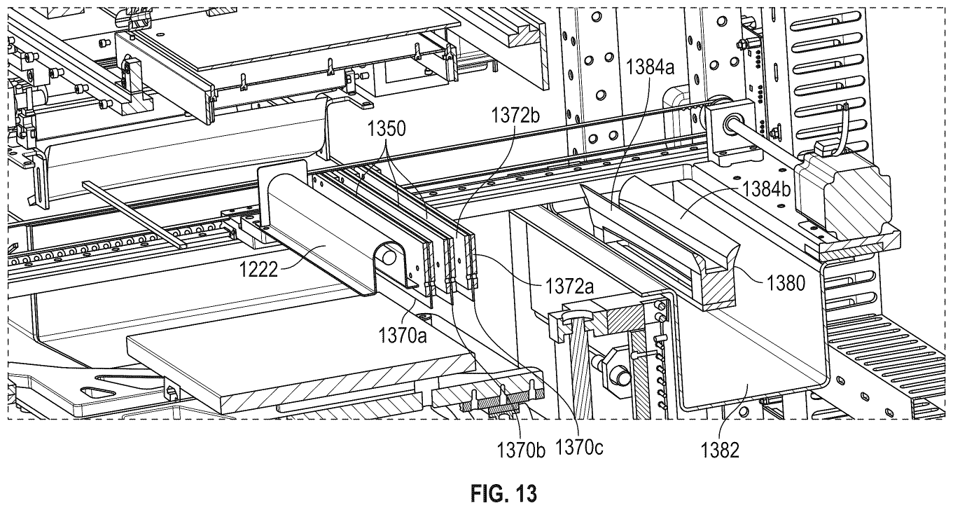

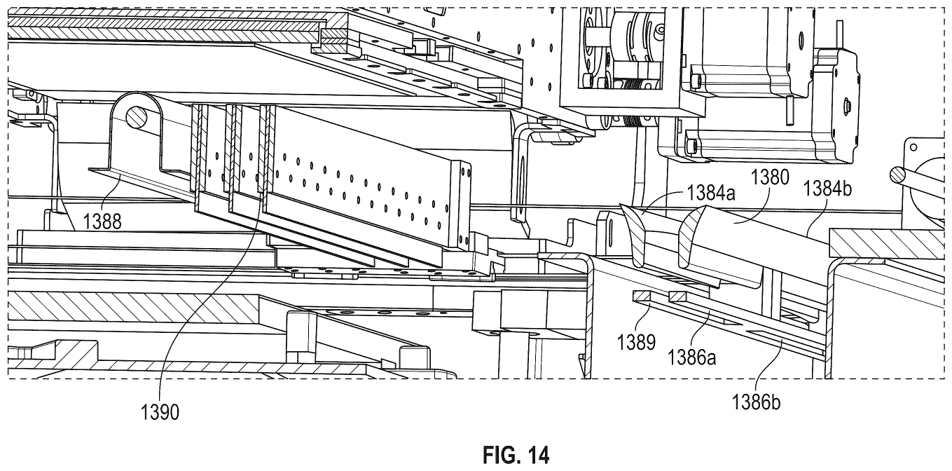

FIG. 13 illustrates a cross-section of an embodiment of the elongate carriage 1222 and additional carriages 1350. Similar to brush 276, brush bristles act like small squeegees or spatulas, removing excess uncured polymer precursor from the printed component 144. The elongate carriage 1222 may include a brush, such as the brush 276 described above. In embodiments, the brush is suspended rotatably, in the elongate carriage 1222 and extends from the base 1388 of the elongate carriage 1222 (illustrated in FIG. 14). The rotational direction and speed can be controlled, to adjust the direction and speed according to the material or the geometry to be cleaned. It should be appreciated, however, that the brush may be omitted and a blade may be provided in the elongate carriage 1222 as described further herein, or as described above.

The additional carriages 1350 include various blades 1370a, 1370b, 1370c. The various blade 1370a, 1370b, 1370c may exhibit different durometers, widths, heights, and vertical cut geometries to accommodate various printed geometries. Like blades 274, 280, the blades 1370a, 1370b, 1370c function like spatulas scaping excess, uncured polymer precursor from the component 144. With reference to blade 1370c, each blade 1370a, 1370b, 1370c is held in place by one or more stabilization bars 1372a, 1372b. The stabilization bars 1372a, 1372b may also function as shims for accommodating blades 1370a, 1370b, 1370c of varying thicknesses. The stabilization bars 1372a, 1372b are connected to the brackets 1354a, 1354b at either end of the stabilization bars 1372a, 1372b. The blades 1370a, 1370b, 1370c extend down from the base 1390 of the stabilization bars illustrated in FIG. 14.

Alternatively, or additionally, the blades may be replaced with a brush, air blade, or IR lamp. In embodiments, an air blade(s) is connected to an air compressor, and the pressure and flow rate of the air may be adjusted depending on the characteristics of the polymer precursor.

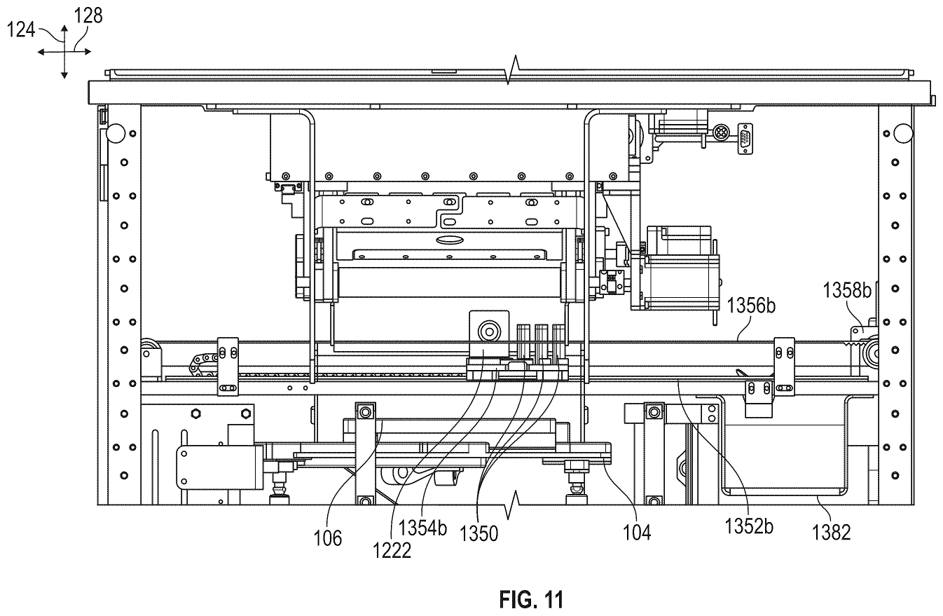

Similar to above, a rest or parking area is provided where cleaning or purging operations can be performed to avoid saturation of the cleaning elements, i.e., the brush and blades 1370a, 1370b, 1370c. In embodiments, the cleaning elements pass over a scraper 1380 extending out of a catch basin 1382 to a park area as illustrated in FIGS. 11 and 13. As illustrated, the scraper 1380 is connected to the inside of the catch basin 1382 and in alternative embodiments is connected to the rails 1366a, 1366b. The scraper 1380 scrapes off the polymer precursor present on the cleaning elements as the cleaning system 220 passes over the catch basin 1382 and the polymer precursor drops into the catch basin 1382. The catch basin 1382 may be connected to a supply drum and the polymer precursor returned to the supply drum. The scraper 1380 includes at least one curved edge 1384a, 1384b extending the width of the blades 1370a, 1370b, 1370c. Each curved edge 1384a, 1384b is positioned at a height relative to the blades 1370a, 1370b, 1370c such that the curved edges 1384a, 1384b contact with the blades 1370a, 1370b, 1370c, as the blades 1370a, 1370b, 1370c pass over the scraper 1380. As illustrated, the curved edges 1384a, 1384b may curve away from each other, or in alternative embodiments, curve in the same direction. As illustrated in FIG. 14, the scraper 1380 defines openings 1386a, 1386b in the base 1389 of the scraper 1380 extending between the curved edges 1384a, 1384b so that the polymer precursor may drip into the catch basin 1382. In embodiments, the carriage 222 may be configured to move back and forth over the scraper 1380 multiple times or pause as the brush in the elongate carriage 1222 is rotated against one of the curved edges 1384a, 1384b. Alternatively, a cleaning substrate is provided in the park areas, made of an absorbent pad, allowing the spatulas and/or the brushes to be cleaned by friction and interference, or that the brushes are revolved to evacuate excess material. The cleaning substrate must be a consumable, and there must be a constant supply of unsaturated cleaning substrate that allows the necessary cleaning routines of the subassembly.

It should be appreciated that the features of the embodiments described above may be interchangeable between the embodiments. Further, the orientation of either of the cleaning systems disclosed herein may be rotated in the x-y plane formed by the second axis 126 and third axis 128. Further, in alternative embodiments, the elongate carriage 222 may be supported over the print bed 104 by other mechanisms, such as one or more swinging assemblies, where the first elongate carriage 222 or individual cleaning elements, i.e., spatulas and brushes (discussed further herein), are mounted to a pendulum that is mounted on the additive manufacturing machine 100 frame 101. The swinging assembly can adjust its angle of attack on the surface to be cleaned through an angular actuator, as it moves along the printing surface driven by a linear actuator mechanism. The rotation speed and direction of rotation of the brush are controllable. The tilting of the system to select the spatula-brush assembly can be powered by a rotary actuator, such as a servomotor, or pneumatically/hydraulically actuated, or by a positioning mechanism that, given a sequence of predefined mechanical interferences, allows the selection of a preferred position of the assembly, or powered by a solenoid. The assembly can be tilting, so that there is a spatula and brush assembly dedicated to cleaning each material. For example, if it is about cleaning a print of 2 materials, the subsystem will have 2 pairs of spatula and brush. If there were 5 materials, the tilting subsystem would have 5 sets, arranged in a rotary drum. These mechanisms may also be driven along the length of the print bed 104 by the linear actuators 224a, 224b described above.

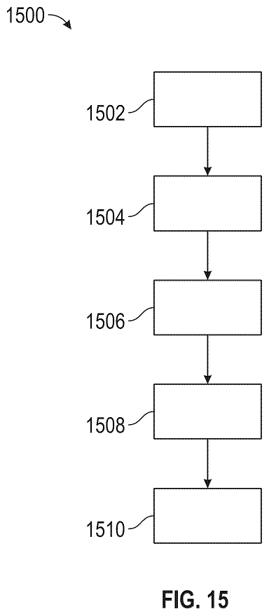

As illustrated in FIG. 15, and with further reference to FIGS. 1 through 14, a method 1500 of cleaning a component 144 as the component 144 is being printed includes, at block 1510 printing layer 142n+1 with a first polymer precursor. At block 1520 after layer 142n+1 is at least partially cured, the print bed 104 is moved to a predefined clean position in the first, z-axis 124, where the print bed 104 and layer 142n+1 is positioned at a height so that layer 142n+1 will interact with the blades 274, 280 and the brush 276 illustrated in FIGS. 1 through 9, or the brush and blades 1370a, 1370b, 1370c illustrated in FIGS. 10 through 14. At block 1530 the carriage 222, or elongate carriage 1222 and blades 1370 a, 1370 b, 1370 c, are moved over the layer 142n+1 to remove any excess first polymer precursor that may have peeled off the transfer film 110 with the layer 142n+1. In the case of the carriage 222, the first elongate brush 276 and blades 274, 280 are enabled, i.e., have been selected, to desired the specifications for the polymer precursor, and any of the rotating speeds, air pressure, advancement speeds or other variables are selected based on the polymer precursor and part geometry. The cleaning system 220 and carriage 222 or elongate carriage 1222 and additional carriages 1350a, 1350b, 1350c performs as many strokes as needed, according to the presets defined for a given print job. If a single polymer precursor is used, the method is repeated at this stage, if a second polymer precursor is used, the method continues at block 1540.

At block 1540 the next layer 142n+1 is printed with a second polymer precursor. While this layer is being printed, the first carriage 222 moved to the rest position and performs a cleaning procedure as described above, being physically contacted with an scraper edge or an absorbent material. At block 1550 after the next layer 142n+1 of the second polymer precursor is at least partially cured, the print bed 104 is moved to a predefined clean position in the first, z-axis 124, where the print bed 104 and layer 142n+1 is positioned at a height so that layer 142n+1 will interact with the blades 274, 280 and the brush 276 of a second carriage 222. Alternatively, the first carriage 222 may be used and different blades and brushes may be used to clean the next layer 142n+1. At block 1560 the second carriage 222, (or first carriage 222 in alternative embodiments), is moved over the second layer 142n+1 to remove any excess second polymer precursor that may have peeled off the transfer film 112 with the second layer 142n+1. At block 1570 the next layer 142n+1 is being deposited with either the first or second polymer precursor and the second carriage 222 (or first carriage 222, if used) is moved to its rest position and performs a cleaning procedure as described above.

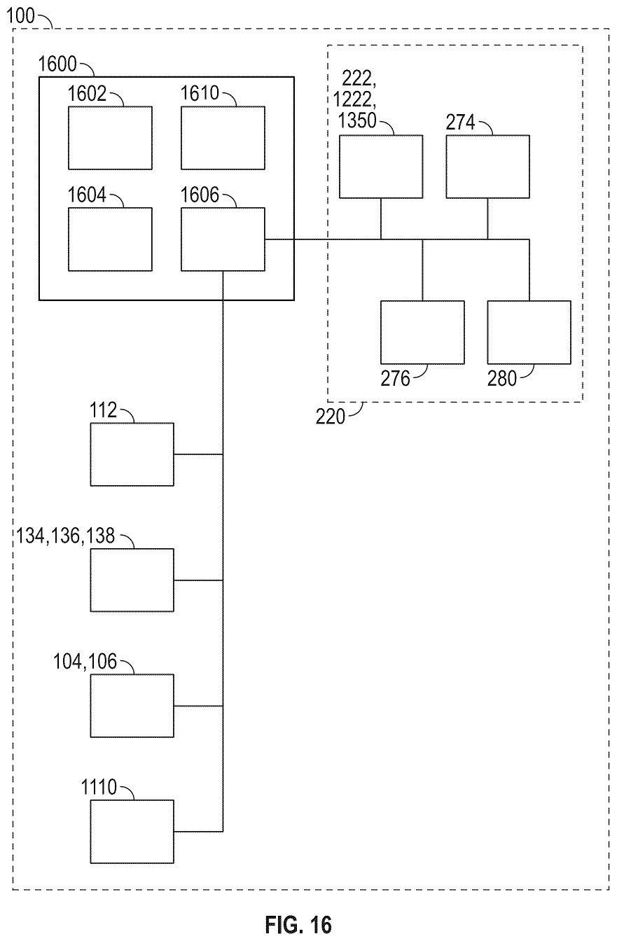

The additive manufacturing machine 100 also includes a control system 1100, illustrated in FIG. 16. The control system 1600 includes a controller 1602 for executing instructions for performing the methods described herein. As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 1602 may also consist of multiple controllers which are in electrical communication with each other. The controller 1602 may be inter-connected with additional systems and/or controllers of the additive manufacturing machine 100, allowing the controller 1602 to access data such as, for example, speed, acceleration, temperatures, pressures, and various other process characteristics of the additive manufacturing machine 100.

The controller 1602 includes one or more processors. The processors may be a custom made or commercially available processor, a central processing unit (CPU), a graphics processing unit (GPU), an auxiliary processor among several processors associated with the controller 1602, a semi composite conductor-based microprocessor (in the form of a microchip or chip set), a macroprocessor, a combination thereof, or generally a device for executing instructions.

Various inputs, data sets, and instructions used in the operation of the controller may be stored in tangible, non-transitory memory 1604. The tangible, non-transitory memory 1604 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 1104 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 1602 to control various systems of the additive manufacturing machine 100.

In addition, for communicating information associated with printing the component, such as g-code and m-code, input variables, and system status, the control system 1600 also includes a communication device 1606. The communication device 1606 includes one or more interface circuits. In some examples, the interface circuits include wired or wireless interfaces that are connected to a local area network (LAN), the Internet, a wide area network (WAN), wireless local area networks (WLAN), cellular networks, or combinations thereof. The controller 1602 may interact with one or more external controllers, such as those located remotely (i.e., in the cloud), or on local networks. In embodiments, the functions described herein relative to the controller 1602 located “on-board” the additive manufacturing machine 100, may be performed using the external controller, which then feeds instructions for performance by the additive manufacturing machine 100 back to the local controller 1602.

In operation of the cleaning system 220, the controller 1602 uses information from location sensors associated with at least one of the transfer film management system 112 regarding positioning of the transfer film 110 relative to the light engine 116, sensors associated with the linear actuators 134a, 134b, 134c regarding positioning of the print bed 104 and support surface 106, as well as data 1610 including information regarding the polymer precursor and the component 114 geometry to make determinations regarding the action of the cleaning system 220 including the number of passes the one or more carriages 222, 1222 and 1350 a, 1350 b, 1350 c make relative to the next layer 142n+1 of component 144, the proper cleaning elements, e.g., the blades 274, 280, 1370a, 1370b, 1370c and brushes 276, to interact with the component 144 and the order the cleaning elements interact with the component 144. The controller 1602 also provides instructions to the cleaning system 220 including instructions regarding the movement of the carriage 222, 1222 and 1350a, 1350b, 1350c and, in embodiments, movement of the cleaning elements, e.g., the blades 274, 280 and brushes 276, carried by the carriage 222.

The apparatus and methods described in the present disclosure provide a number of advantages. These advantages include the removal of excess resin, powder, or other printing material from the surfaces, cavities, and contours of the component being printed. Another advantage is the ability to prevent cross-contamination if multiple materials are being used to print the component. A further advantage is the applicability of the system to any 3D printing system whose feed material has the ability to flow when subjected to a shear force (for example, resin or powder). In addition, a further advantage is the ability to combine multiple materials in a single cross-section, i.e., layer, allowing for a sharp separation between material regions. In yet another advantage, the system may be used in applications that required immediate surface cleaning before conducting other assembly operations, such as welding etc.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for removing excess polymer precursor, comprising:
a print bed;
a light engine positioned over the print bed;
a first elongate carriage suspended between the print bed and the light engine, wherein the first elongate carriage defines a first base; and
a first blade connected to the first elongate carriage, wherein at least a portion of the first blade extends from the first base,
wherein the first elongate carriage is movable in a first plane parallel to a second plane defined by the print bed.

2. The system of claim 1, wherein the first elongate carriage is movable in the first plane by a linear actuator and the first elongate carriage is connected to a track.

3. The system of claim 2, wherein the first elongate carriage includes a first end and a second end and is connected to a track at each end.

4. The system of claim 2, wherein the linear actuator is a motor and a pulley.

5. The system of claim 4, wherein the first elongate carriage is connected to the track by a bracket, wherein the bracket and the track include a linear encoder.

6. The system of claim 1, further comprising an additional elongate carriage, wherein the additional elongate carriage includes an additional blade extending from a base of the additional elongate carriage.

7. The system of claim 1, further comprising a first elongate brush connected to the first elongate carriage, wherein at least a portion of the first elongate brush extends from the first base.

8. The system of claim 7, further comprising a second blade movable relative to the print bed, wherein the first blade is located proximal to a first side of the first elongate brush and the second blade is located proximal to a second side of the first elongate brush.

9. The system of claim 1, wherein the first elongate carriage further includes a second blade.

10. The system of claim 9, further comprising a second elongate carriage suspended over the print bed, wherein the second elongate carriage defines a second base;
a third blade connected to the second elongate carriage, wherein at least a portion of the third blade extends from the second base; and
a second elongate brush connected to the second elongate carriage, wherein at least a portion of the second elongate brush extends from the second base.

11. The system of claim 1, wherein the first blade includes at least one of spatula, an air blade, and a conveyor belt.

12. The system of claim 1, further comprising at least one of a scraper and an absorbent pad, wherein the first blade contacts the at least one of the scraper and the absorbent pad when moved to a rest position.

13. The system of claim 12, wherein the scraper extends out of a catch basin, wherein the scraper includes at least one first curved edge extending a width of the first blade and is positioned at a height that allows the first blade to contact the first curved edge upon passing over the first curved edge.

14. The system of claim 13, wherein the scraper further includes a second curved edge and the second curved edge is curved in the opposite direction of the first curved edge, and the scraper defines openings in a base of the scraper extending between the first curved edge and the second curved edge.

15. A method for removing excess polymer precursor from an additive manufacturing machine, comprising:
forming a first layer of an at least partially cured first polymer precursor on a print bed;
advancing a first elongate carriage suspended over the print bed, wherein the first elongate carriage defines a first base, and a first blade connected to the first elongate carriage, wherein at least a portion of the first blade extends from the first base to contact the first layer of the at least partially cured first polymer precursor;
removing uncured first polymer precursor from the first layer of the at least partially cured first polymer precursor with the first blade; and
retracting the first elongate carriage.

16. The method of claim 15, further comprising cleaning the uncured first polymer precursor from the first blade with a scraper having a first curved edge, wherein the first curved edge of the scraper contacts the first blade.

17. The method of claim 15, further comprising:
depositing the first layer of a first polymer precursor on a transfer film;
contacting the print bed with the first polymer precursor; and
emitting light onto the first polymer precursor.

18. The method of claim 15, further comprising:
forming a second layer of an at least partially cured second polymer precursor on the print bed;
advancing a second elongate carriage suspended over the print bed, wherein the second elongate carriage defines a second base, a second blade connected to the second elongate carriage, wherein at least a portion of the second blade extends from the second base, and a second elongate brush connected to the second elongate carriage, wherein at least a portion of the second elongate brush extends from the second base to contact the second layer of the at least partially cured second polymer precursor;
removing excess second polymer precursor from the second layer of the at least partially cured second polymer precursor with the second blade and the second elongate brush; and
retracting the second elongate carriage.

19. The method of claim 18, further comprising:
depositing a second layer of a second polymer precursor on a transfer film;
contacting the first layer with the second polymer precursor; and
emitting light onto the second polymer precursor.

20. The method of claim 15, further comprising:
forming a second layer of an at least partially cured second polymer precursor on the print bed;
advancing the first elongate carriage suspended over the print bed, wherein the first elongate carriage includes a second blade connected to the first elongate carriage, wherein at least a portion of the second blade extends from the first base, and a second elongate brush connected to the first elongate carriage, wherein at least a portion of the second elongate brush extends from the first base to contact the second layer of the at least partially cured second polymer precursor;
removing excess second polymer precursor from the second layer of the at least partially cured second polymer precursor with the second blade and the second elongate brush; and
retracting the first elongate carriage.
